(19) United States
(12) Patent Application Publication
(10) Pub. No.: US 2014/0349905 A1
(43) Pub. Date: Nov. 27, 2014

(54) SULFOPOLYMER-CONTAINING LIQUID CLEANING AGENT WITH LOW WATER CONTENT

(71) Applicant: Henkel AG & Co. KGaA, Duesseldorf (DE)

(72) Inventors: Konstantin Benda, Duesseldorf (DE); Thomas Eiting, Duesseldorf (DE); Nina Mussmann, Willich (DE); Thorsten Bastigkeit, Wuppertal (DE)

(21) Appl. No.: 14/458,379

(22) Filed: Aug. 13, 2014

Related U.S. Application Data
(63) Continuation of application No. PCT/EP2012/071716, filed on Nov. 2, 2012.

(30) Foreign Application Priority Data
Feb. 14, 2012 (DE) 10 2012 202 176.0

(51) Int. Cl. C11D 3/20; C11D 3/37; C11D 17/00

(52) U.S. Cl. CPC C11D 3/2065; C11D 17/0039; C11D 3/37
USPC 510/224

(57) ABSTRACT

A liquid cleaning agent in a water-soluble packaging containing at least one sulfopolymer and at least one polyhydric alcohol.

### FIELD OF THE INVENTION

The present invention generally relates to liquid cleaning agents in a water-soluble packaging, containing at least one sulfopolymer and at least one polyhydric alcohol, to a method for the production thereof and to a method for using automatic dishwashing agents.

### BACKGROUND OF THE INVENTION

Consumers have got used to the ease with which pre-portioned automatic dishwashing agents can be dispensed and use these products above all in the form of tablets. However, liquid presentations in the form of multifunctional gels are becoming ever more readily available commercially. In particular the rapid solubility and associated rapid availability of the active ingredients offers advantages in particular in reduced-length washing programs. From the consumer's viewpoint it is desirable to combine the advantages of the two presentations, resulting in a pre-portioned liquid product.

To turn a liquid dishwashing agent into a pre-portioned presentation, it is conventional to use cold-water-soluble films in the form of pouches. However, this limits the formulations that can be developed, since only a limited amount of water can be incorporated into the product. If the acceptable amount of water is exceeded, the enveloping water-soluble film dissolves prematurely.

In particular, the incorporation of polymers, which are essential to the good performance of a multifunctional product, entails significant difficulties in formulations which must comprise only small quantities of water.

It has however now surprisingly been found that the incorporation of sulfopolymers into a cleaning agent formulation is possible even in the case of a small quantity of water, in particular where the quantity of water is limited to at most 25 wt. %, in particular at most 20 wt. %, if the composition contains at least one polyhydric alcohol.

The present application accordingly firstly provides a liquid cleaning agent in a water-soluble packaging, containing at least one sulfopolymer and at least one polyhydric alcohol.

The cleaning agent according to the invention is preferably a dishwashing agent, in particular an automatic dishwashing agent.

The present invention also provides an automatic dishwashing method, in which a cleaning agent according to the invention is used.

The present invention also provides a method for producing liquid cleaning agents in a water-soluble packaging, containing at least one sulfopolymer and at least one polyhydric alcohol, wherein the sulfopolymer is used in solid form.

Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A liquid cleaning agent in a water-soluble packaging containing at least one sulfopolymer and at least one polyhydric alcohol.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The quantity of polyhydric alcohol or polyhydric alcohols used in cleaning agents according to the invention is preferably at least 20 wt. %, in particular at least 25 wt. %, more preferably at least 28 wt. %, above all at least 30 wt. %. Preferred quantity ranges are in this case 20 to 50 wt. %, in particular 25 to 45 wt. %, above all 28 to 40 wt. %.

The polyhydric alcohol is preferably selected from glycerol, ethylene glycol, 1,2-propylene glycol, 1,3-propylene glycol and mixtures thereof.

In a preferred embodiment, a mixture of at least two polyhydric alcohols is used.

A polyhydric alcohol more preferably used according to the invention is 1,2-propylene glycol. 1,2-Propylene glycol is used in agents according to the invention preferably in a quantity of 1 to 40 wt. %, in particular in a quantity of 15 to 35 wt. %, more preferably in a quantity of 20 to 30 wt. %.

A further polyhydric alcohol more preferably used according to the invention is glycerol. Glycerol is used in agents according to the invention preferably in a quantity of 0.1 to 15 wt. %, in particular in a quantity of 1 to 10 wt. %, more preferably in a quantity of 3 to 7 wt. %.

In one more preferred embodiment, a mixture of glycerol and 1,2-propylene glycol is used.

Glycerol is in this case preferably used in a quantity of 0.1 to 15 wt. %, in particular in a quantity of 1 to 10 wt. %, more preferably in a quantity of 3 to 7 wt. %. 1,2-Propylene glycol is in this case preferably used in a quantity of 1 to 40 wt. %, in particular in a quantity of 15 to 35 wt. %, more preferably in a quantity of 20 to 30 wt. %, in each case relative to the total quantity of cleaning agent, wherein the total quantity of glycerol and 1,2-propylene glycol preferably amounts to at least 20 wt. %, in particular at least 25 wt. %, above all at least 28 wt. %, more preferably 25 to 45 wt. %, in particular 28 to 40 wt. %, above all 28.5 to 32.0 wt. %.

The liquid cleaning agent is preferably a water-containing composition. The water content of the composition according to the invention is preferably at most 25 wt. % and preferably below 20 wt. %. Preferred quantity ranges are in this case 5 to 25 wt. %, in particular 15 to 20 wt. %, above all 18 to 19.8 wt. %.

The proportion by weight of the sulfopolymer in the total weight of the cleaning agent according to the invention preferably amounts to from 0.1 to 20 wt. %, in particular from 0.5 to 18 wt. %, more preferably 1.0 to 15 wt. %, in particular from 4 to 14 wt. %, above all from 6 to 12 wt. %.

The sulfopolymer used is preferably a copolymeric polysulfonate, preferably a hydrophobically modified copolymeric polysulfonate.

The copolymers may comprise two, three, four or more different monomer units.

Preferred copolymeric polysulfonates contain, in addition to monomer(s) containing sulfonic acid groups, at least one monomer from the group of unsaturated carboxylic acids.

The unsaturated carboxylic acid(s) used with particular preference are unsaturated carboxylic acids of the formula R¹(R²)C═C(R³)COOH, in which R¹ to R³ mutually independently denote —H, —CH₃, a straight-chain or branched saturated alkyl residue with 2 to 12 carbon atoms, a straight-chain or branched, mono- or polyunsaturated alkenyl residue with 2 to 12 carbon atoms, alkyl or alkenyl residues substituted with —NH₂, —OH or —COOH as defined above or denote —COOH or —COOR⁴, wherein R⁴ is a saturated or unsaturated, straight-chain or branched hydrocarbon residue with 1 to 12 carbon atoms.

More preferred unsaturated carboxylic acids are acrylic acid, methacrylic acid, ethacrylic acid, α-chloroacrylic acid, α-cyanoacrylic acid, crotonic acid, α-phenylacrylic acid, maleic acid, maleic anhydride, fumaric acid, itaconic acid, citraconic acid, methylenemalonic acid, sorbic acid, cinnamic acid or mixtures thereof. Unsaturated dicarboxylic acids may, of course, also be used.

Preferred monomers containing sulfonic acid groups are those of the formula

R⁵(R⁶)C═C(R⁷)—X—SO₃H

in which R⁵ to R⁷ mutually independently denote —H, —CH₃, a straight-chain or branched saturated alkyl residue with 2 to 12 carbon atoms, a straight-chain or branched, mono- or polyunsaturated alkenyl residue with 2 to 12 carbon atoms, alkyl or alkenyl residues substituted with —NH₂, —OH or —COOH, or denote —COOH or —COOR⁴, wherein R⁴ is a saturated or unsaturated, straight-chain or branched hydrocarbon residue with 1 to 12 carbon atoms, and X denotes an optionally present spacer group which is selected from —(CH₂)ₙ— with n=0 to 4, —COO—(CH₂)ₖ— with k=1 to 6, —C(O)—NH—C(CH₃)₂—, —C(O)—NH—C(CH₃)₂CH₂— and —C(O)—NH—CH(CH₃)—CH₂—.

Preferred among these monomers are those of the formulae

H₂C═CH—X—SO₃H

H₂C═C(CH₃)—X—SO₃H

HO₃S—X—(R⁶)C═C(R⁷)—X—SO₃H,

in which R⁶ and R⁷ are mutually independently selected from —H, —CH₃, —CH₂CH₃, —CH₂CH₂CH₃, —CH(CH₃)₂ and X denotes an optionally present spacer group, which is selected from —(CH₂)ₙ— with n=0 to 4, —COO—(CH₂)ₖ— with k=1 to 6, —C(O)—NH—C(CH₃)₂—, —C(O)—NH—C(CH₃)2-CH₂— and —C(O)—NH—CH(CH₃)—CH₂—

More preferred monomers containing sulfonic acid groups are here 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethylmethacrylamide and mixtures of the stated acids or the water-soluble salts thereof.

The sulfonic acid groups may be present in the polymers entirely or in part in neutralized form, i.e. the acidic hydrogen atom of the sulfonic acid group may be replaced in some or all of the sulfonic acid groups with metal ions, preferably alkali metal ions and in particular with sodium ions. It is preferred according to the invention to use copolymers containing partially or completely neutralized sulfonic acid groups.

In copolymers which contain only monomers containing carboxylic acid groups and monomers containing sulfonic acid groups, the monomer distribution of the copolymers preferably used according to the invention amounts preferably in each case to 5 to 95 wt. %, and more preferably the proportion of the monomer containing sulfonic acid groups amounts to 50 to 90 wt. % and the proportion of the monomer containing carboxylic acid groups amounts to 10 to 50 wt. %, the monomers here preferably being selected from those stated above.

The molar mass of the sulfo copolymers preferably used according to the invention may be varied in order to tailor the properties of the polymers to the desired intended application. Preferred cleaning agents are characterized in that the copolymers exhibit molar masses of 2000 to 200,000 gmol⁻¹, preferably of 4000 to 25,000 gmol⁻¹ and in particular of 5000 to 15,000 gmol⁻¹.

In a further preferred embodiment, in addition to a monomer containing carboxyl groups and a monomer containing sulfonic acid groups, the copolymers further comprise at least one nonionic, preferably hydrophobic monomer. It has in particular been possible to improve the rinsing performance of automatic dishwashing agents according to the invention by using these hydrophobically modified polymers.

Cleaning agents characterized in that the agent contains as anionic copolymer a copolymer comprising
1. monomers containing carboxylic acid groups
2. monomers containing sulfonic acid groups
3. nonionic monomers, in particular hydrophobic monomers are preferred according to the invention.

Preferably used nonionic monomers are those of the general formula R¹(R²)C═C(R³)—X—R⁴, in which R¹ to R³ mutually independently denote —H, —CH₃ or —C₂H₅, X denotes an optionally present spacer group which is selected from —CH₂—, —C(O)O— and —C(O)—NH—, and R⁴ denotes a straight-chain or branched saturated alkyl residue with 2 to 22 carbon atoms or denotes an unsaturated, preferably aromatic residue with 6 to 22 carbon atoms.

More preferred nonionic monomers are butene, isobutene, pentene, 3-methylbutene, 2-methylbutene, cyclopentene, hexene, 1-hexene, 2-methyl-1-pentene, 3-methyl-1-pentene, cyclohexene, methylcyclopentene, cycloheptene, methylcyclohexene, 2,4,4-trimethyl-1-pentene, 2,4,4-trimethyl-2-pentene, 2,3-dimethyl-1-hexene, 2,4-dimethyl-1-hexene, 2,5-dimethyl-1-hexene, 3,5-dimethyl-1-hexene, 4,4-dimethyl-1-hexane, ethylcyclohexyne, 1-octene, α-olefins with 10 or more carbon atoms such as for example 1-decene, 1-dodecene, 1-hexadecene, 1-octadecene and C₂₂ α-olefin, 2-styrene, α-methylstyrene, 3-methylstyrene, 4-propylstyrene, 4-cyclohexylstyrene, 4-dodecylstyrene, 2-ethyl-4-benzylstyrene, 1-vinylnaphthalene, 2-vinylnaphthalene, methyl acrylate, ethyl acrylate, propyl acrylate, butyl acrylate, pentyl acrylate, hexyl acrylate, methyl methacrylate, N-(methyl)acrylamide, 2-ethylhexyl acrylate, 2-ethylhexyl methacrylate, N-(2-ethylhexyl)acrylamide, octyl acrylate, octyl methacrylate, N-(octyl)acrylamide, lauryl acrylate, lauryl methacrylate, N-(lauryl)acrylamide, stearyl acrylate, stearyl methacrylate, N-(stearyl)acrylamide, behenyl acrylate, behenyl methacrylate and N-(behenyl)acrylamide or mixtures thereof.

The monomer distribution of the hydrophobically modified copolymers preferably used according to the invention amounts with regard to the monomer containing sulfonic acid groups, the hydrophobic monomer and the monomer containing carboxylic acid groups preferably in each case to 5 to 80 wt. %, and more preferably the proportion of the monomer containing sulfonic acid groups and of the hydrophobic monomer in each case amounts to 5 to 30 wt. % and the proportion of the monomer containing carboxylic acid groups amounts to 60 to 80 wt. %, the monomers here preferably being selected from those stated above.

In a preferred embodiment of the invention, the liquid and hydrous cleaning agent contains water in a proportion of at most 25 wt. %, preferably up to 20 wt. % in combination with sulfopolymer, which was used in the production of the agent in solid form. It has been found that solid sulfopolymer is successfully incorporated in homogeneous and stable manner if at least one polyhydric alcohol is present in the agent.

In a further more preferred embodiment of the invention, the liquid and hydrous cleaning agent contains water up to at most 25 wt. %, sulfopolymer, which was used in production of the agent in solid form, and a mixture of glycerol and propylene glycol as the polyhydric alcohols.

The cleaning agent according to the invention is preferably contained in water-soluble packaging. The water-soluble packaging allows portioning of the cleaning agent. The quantity of cleaning agents in the portion pack preferably amounts to 5 to 50 g, more preferably 10 to 30 g, above all 15 to 25 g.

The water-soluble packaging preferably comprises a water-soluble polymer. Some preferred water-soluble polymers, which are preferably used as water-soluble packaging, are polyvinyl alcohols, acetalized polyvinyl alcohols, polyvinylpyrrolidone, polyethylene oxides, celluloses and gelatin, wherein polyvinyl alcohols and acetalized polyvinyl alcohols are more preferably used.

“Polyvinyl alcohols” (abbreviated PVAL, occasionally also PVOH) is the name given to polymers of the general structure

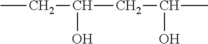

which also contain small proportions (approx. 2%) of structural units of the type

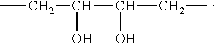

Conventional commercial polyvinyl alcohols, which are offered for sale as white-yellowish powders or granules with degrees of polymerization in the range from approx. 100 to 2500 (molar masses of approx. 4000 to 100,000 g/mol), have degrees of hydrolysis of 87-99 mol %, and thus still have a residual content of acetyl groups.

For the purposes of the present invention, it is preferable for the water-soluble packaging to comprise at least a proportion of a polyvinyl alcohol, the degree of hydrolysis of which amounts preferably to 70 to 100 mol %, in particular 80 to 90 mol %, more preferably 81 to 89 mol % and above all 82 to 88 mol %. In a preferred embodiment, the water-soluble packaging consists to an extent of at least 20 wt. %, more preferably of at least 40 wt. %, particularly preferably of at least 60 wt. % and in particular of at least 80 wt. % of a polyvinyl alcohol having a degree of hydrolysis of 70 to 100 mol %, preferably of 80 to 90 mol %, more preferably of 81 to 89 mol % and in particular of 82 to 88 mol %.

The materials used for the packaging are preferably polyvinyl alcohols of a specific molecular weight range, wherein it is preferred according to the invention for the material to comprise a polyvinyl alcohol having a molecular weight in the range from 5,000 to 100,000 gmol⁻¹, preferably of 10,000 to 90,000 gmol⁻¹, more preferably of 12,000 to 80,000 gmol⁻¹ and in particular of 15,000 to 70,000 gmol⁻¹.

The degree of polymerization of such preferred polyvinyl alcohols is between approx. 200 to approx. 2100, preferably between approx. 220 to approx. 1890, more preferably between approx. 240 to approx. 1680 and in particular between approx. 260 to approx. 1500.

The water solubility of polyvinyl alcohol may be modified by post-treatment with aldehydes (acetalization) or ketones (ketalization). Polyvinyl alcohols which are acetalized or ketalized with the aldehyde or keto groups of saccharides or polysaccharides or mixtures thereof have proved to be more preferred and particularly advantageous due to their markedly good cold water solubility. The reaction products of polyvinyl alcohol and starch may extremely advantageously be used. Water solubility may furthermore be modified by complexation with Ni or Cu salts or by treatment with dichromates, boric acid or borax and so purposefully be adjusted to desired values.

The water-soluble packaging preferably has a thickness of 10 μm to 500 μm, in particular of 20 μm to 400 μm, more preferably of 30 μm to 300 μm, above all of 40 μm to 200 μm, in particular of 50 μm to 150 μm.

A polyvinyl alcohol which is more preferably used is obtainable for example under the trade name M8630 (Monosol).

The viscosity of cleaning agents according to the invention is preferably above 4000 mPa·s (Brookfield Viscometer DV-II+Pro, spindle 25, 30 rpm, 20° C.), in particular between 4000 and 7000 mPa·s, more preferably between 4500 and 6500 mPa·s, above all between 5000 and 6000 mPa·s.

The pH value of cleaning agents according to the invention is preferably between 6 and 10, more preferably between 7 and 9, above all between 7 and 8.

Cleaning agents according to the invention preferably further contain at least one nonionic surfactant. Any nonionic surfactants known to a person skilled in the art may be used as the nonionic surfactants. Low-foaming nonionic surfactants are preferably used, in particular alkoxylated, above all ethoxylated, low-foaming nonionic surfactants.

Preferred nonionic surfactants are here those of the general formula R¹—CH(OH)CH₂O-(AO)_{w}-(A′O)ₓ-(A″O)_{y}-(A′″O)_{z}—R², in which
R¹ denotes a straight-chain or branched, saturated or mono- or polyunsaturated C₆₋₂₄ alkyl or alkenyl residue;
R² denotes hydrogen or a linear or branched hydrocarbon residue with 2 to 26 carbon atoms;
A, A′, A″ and A′″ mutually independently denote a residue from the group comprising —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃),
w, x, y and z denote values between 0.5 and 120, wherein x, y and/or z may also be 0.

By adding the above-stated nonionic surfactants of the general formula R¹—CH(OH)CH₂O-(AO)_{w}-(A′O)ₓ-(A″O)_{y}-(A′″O)_{z}—R², hereinafter also known as “hydroxy mixed ether”, the cleaning performance of preparations according to the invention can surprisingly be significantly improved, both in comparison with surfactant-free systems and also in comparison with systems which contain alternative nonionic surfactants, for example from the group of polyalkoxylated fatty alcohols.

By using these nonionic surfactants with one or more free hydroxyl groups at one or both terminal alkyl residues, the stability of the enzymes contained in the cleaning agent preparations according to the invention may be markedly improved.

In particular, preferred end group-terminated poly(oxyalkylated) nonionic surfactants are those which, according to the formula R¹O[CH₂CH₂O]ₓCH₂CH(OH)R², in addition to a residue R¹, which denotes linear or branched, saturated or unsaturated, aliphatic or aromatic hydrocarbon residues with 2 to 30 carbon atoms, preferably with 4 to 22 carbon atoms, furthermore comprise a linear or branched, saturated or unsaturated, aliphatic or aromatic hydrocarbon residue R² with 1 to 30 carbon atoms, wherein x denotes values between 1 and 90, preferably values between 30 and 80 and in particular values between 30 and 60.

Surfactants of the formula R¹O[CH₂CH(CH₃)O]ₓ[CH₂CH₂O]_{y}CH₂CH(OH)R², in which R¹ denotes a linear or branched aliphatic hydrocarbon residue with 4 to 18 carbon atoms or mixtures thereof, R² denotes a linear or branched hydrocarbon residue with 2 to 26 carbon atoms or mixtures thereof and x denotes values between 0.5 and 1.5 and y denotes a value of at least 15, are more preferred. The group of these nonionic surfactants includes for example C₂₋₂₆ fatty alcohol-(PO)₁-(EO)₁₅₋₄₀-2-hydroxyalkyl ethers, in particular also C₈₋₁₀ fatty alcohol-(PO)₁-(EO)₂₂-2-hydroxydecyl ethers.

More preferred end group-terminated poly(oxyalkylated) nonionic surfactants are furthermore those of the formula R¹O[CH₂CH₂O]ₓ[CH₂CH(R³)O]_{y}CH₂CH(OH)R², in which R¹ and R² mutually independently denote a linear or branched, saturated or mono- or polyunsaturated hydrocarbon residue with 2 to 26 carbon atoms, R³ is mutually independently selected from —CH₃, —CH₂CH₃, —CH₂CH₂—CH₃, —CH(CH₃)₂, but preferably denotes —CH₃, and x and y mutually independently denote values between 1 and 32, wherein nonionic surfactants with R³═—CH₃ and values of x from 15 to 32 and y of 0.5 and 1.5 are particularly preferred.

Further preferred nonionic surfactants which may be used are the end group-terminated poly(oxyalkylated) nonionic surfactants of the formula R¹O[CH₂CH(R³)O]ₓ[CH₂]ₖCH(OH)[CH₂]ⱼOR², in which R¹ and R² denote linear or branched, saturated or unsaturated, aliphatic or aromatic hydrocarbon residues with 1 to 30 carbon atoms, R3 denotes H or a methyl, ethyl, n-propyl, iso-propyl, n-butyl, 2-butyl or 2-methyl-2-butyl residue, x denotes values between 1 and 30, k and j denote values between 1 and 12, preferably between 1 and 5. If the value x is ≧2, each R³ in the above formula R¹O[CH₂CH(R³)O]_{X}[CH₂]ₖCH(OH)[CH₂]ⱼOR² may be different. R¹ and R² are preferably linear or branched, saturated or unsaturated, aliphatic or aromatic hydrocarbon residues with 6 to 22 carbon atoms, wherein residues with 8 to 18 C atoms are more preferred. H, —CH₃ or —CH₂CH₃ are more preferred for the residue R³. More preferred values for x are in the range from 1 to 20, in particular from 6 to 15.

As described above, each R³ in the above formula may be different if x is ≧2. In this manner, it is possible to vary the alkylene oxide unit in the square brackets. For example, if x denotes 3, the residue R³ may be selected in order to form ethylene oxide (R³═H) or propylene oxide (R³═CH₃) units, which may be attached to one another in any sequence, for example (EO)(PO)(EO), (EO)(EO)(PO), (EO)(EO)(EO), (PO)(EO)(PO), (PO)(PO)(EO) and (PO)(PO)(PO). The value 3 for x has been selected here by way of example and may perfectly well be larger, wherein the range of variation increases as the value of x rises and for example comprises a large number of (EO) groups combined with a small number of (PO) groups, or vice versa.

More preferred end group-terminated poly(oxyalkylated) alcohols of the above formula exhibit values of k=1 and j=1, such that the above formula is simplified to R¹O[CH₂CH(R³)O]ₓCH₂CH(OH)CH₂OR². In the latter-stated formula, R¹, R² and R³ are as defined above and x denotes numbers from 1 to 30, preferably from 1 to 20 and in particular from 6 to 18. More preferred surfactants are those in which the residues R¹ and R² comprise 9 to 14 C atoms, R³ denotes H and x assumes values from 6 to 15.

Finally, particularly effective nonionic surfactants of the general formula R¹—CH(OH)CH₂O-(AO)_{w}—R² have proven to be those in which
R¹ denotes a straight-chain or branched, saturated or mono- or polyunsaturated C₆₋₂₄ alkyl or alkenyl residue;
R² denotes a linear or branched hydrocarbon residue having 2 to 26 carbon atoms;
A denotes a residue from the group CH₂CH₂, CH₂CH₂CH₂, CH₂CH(CH₃), preferably CH₂CH₂, and
w denotes values between 1 and 120, preferably 10 to 80, in particular 20 to 40.

The group of these nonionic surfactants includes for example C₄₋₂₂ fatty alcohol-(EO)₁₀₋₈₀-2-hydroxyalkyl ethers, in particular also C₈₋₁₂ fatty alcohol-(EO)₂₂-2-hydroxydecyl ethers and C₄₋₂₂ fatty alcohol-(EO)₄₀₋₈₀-2-hydroxyalkyl ethers.

Preferred liquid cleaning agents are characterized in that the cleaning agent contains at least one nonionic surfactant, preferably a nonionic surfactant from the group of hydroxy mixed ethers, wherein the proportion by weight of the nonionic surfactant preferably amounts to 0.5 to 10 wt. %, preferably 1.0 to 8.0 wt. % and in particular 2,0 to 6.0 wt. % of the total weight of the cleaning agent.

Cleaning agents according to the invention preferably contain one or more builder(s) as a further component. The proportion by weight of these builders relative to the total weight of agents according to the invention preferably amounts to 15 to 80 wt. % and in particular to 20 to 70 wt. %. These builders include in particular carbonates, phosphates, citrates, phosphonates, MGDA, GLDA, EDDS, organic cobuilders and silicates.

It is preferred to use carbonate(s) and/or hydrogencarbonate(s), preferably alkali metal carbonate(s), more preferably sodium carbonate, in quantities of 2 to 30 wt. %, preferably of 4 to 28 wt. % and in particular of 8 to 24 wt. %, in each case relative to the weight of the cleaning agent.

It is furthermore preferred to use phosphate. Among the numerous commercially obtainable phosphates, it is the alkali metal phosphates which have the greatest significance in the washing and cleaning agent industry, with pentasodium or pentapotassium triphosphate (sodium or potassium tripolyphosphate) being more preferred.

“Alkali metal phosphates” is the generic name for the alkali metal (in particular sodium and potassium) salts of the various phosphoric acids, it being possible to distinguish between meta-phosphoric acids (HPO₃)ₙ and ortho-phosphoric acid H₃PO₄ as well as higher molecular weight representatives. The phosphates here combine a number of advantages: they act as alkalinity donors, prevent lime deposits on parts of machinery or lime incrustation of fabrics and, moreover, contribute to cleaning performance.

Phosphates which are more preferred according to the invention are pentasodium triphosphate, Na₅P₃O₁₀ (sodium tripolyphosphate) and the corresponding potassium salt pentapotassium triphosphate, K₅O₃O₁₀ (potassium tripolyphosphate). According to the invention, sodium-potassium tripolyphosphates are furthermore preferably used.

If, for the purposes of the present application, phosphates are used as substances with a cleaning action in the cleaning agents, the latter preferably contain phosphate(s), preferably alkali metal phosphate(s), more preferably pentasodium or pentapotassium triphosphate (sodium or potassium tripolyphosphate), in quantities of 5 to 60 wt. %, preferably of 15 to 45 wt. % and in particular of 20 to 40 wt. %, in each case relative to the weight of the cleaning agent.

In a preferred embodiment according to the invention, the use of phosphates is largely or completely dispensed with. In this embodiment, the agent preferably contains less than 5 wt. %, more preferably less than 3 wt. %, in particular less than 1 wt. % phosphate(s). In this embodiment, the agent is more preferably completely phosphate-free.

Organic cobuilders which may in particular be mentioned are polycarboxylates/polycarboxylic acids, polymeric carboxylates, aspartic acid, polyacetals, dextrins and organic cobuilders. These classes of substances are described below.

Usable organic builder materials are for example polycarboxylic acids usable in the form of the free acid and/or the sodium salts thereof, wherein polycarboxylic acids are taken to mean those carboxylic acids which bear more than one acid function. These are, for example, citric acid, adipic acid, succinic acid, glutaric acid, malic acid, tartaric acid, maleic acid, fumaric acid, saccharic acids, aminocarboxylic acids, and nitrilotriacetic acid (NTA) provided that there are no objections to such use on environmental grounds, together with mixtures thereof. Apart from their builder action, the free acids typically also have the property of an acidifying component and so also serve to establish a lower and gentler pH value for cleaning agents. Citric acid, succinic acid, glutaric acid, adipic acid, gluconic acid and any desired mixtures of these may in particular be mentioned.

More preferred cleaning agents according to the invention contain citrate as one of their essential builders. Cleaning agents which are characterized in that they contain 2 to 40 wt. %, preferably 5 to 30 wt. % and in particular 5 to 20 wt. % of citrate are preferred according to the invention.

More preferred cleaning agents according to the invention are characterized in that the cleaning agent contains at least two builders from the group of phosphates, carbonates and citrates, wherein the proportion by weight of these builders, relative to the total weight of the cleaning agent according to the invention, preferably amounts to 5 to 60 wt. %, preferably to 15 to 50 wt. % and in particular to 25 to 40 wt. %. The combination of two or more builders from the above-stated group has proven to be advantageous for the washing and rinsing performance of automatic dishwashing agents according to the invention.

In an embodiment which is particularly preferred according to the invention, a mixture of phosphate and citrate or a mixture of GLDA and citrate is used, wherein the quantity of phosphate or GLDA preferably amounts to 10 to 35 wt. % and the quantity of citrate preferably to 2 to 10 wt. %, in each case relative to the total quantity of the cleaning agent, wherein the total quantity of these builders preferably amounts to 20 to 35 wt. %, in particular 25 to 35 wt. %.

Further suitable builders are polymeric polycarboxylates, these being for example the alkali metal salts of polyacrylic acid or polymethacrylic acid, for example those with a relative molecular mass of 500 to 70000 g/mol.

Suitable polymers are in particular polyacrylates, which preferably have a molecular mass of 2000 to 20000 g/mol. Due to their superior solubility, the short-chain polyacrylates from this group may in turn be preferred, these having molar masses of from 2000 to 10000 g/mol, and more preferably of from 3000 to 5000 g/mol.

The content of (homo)polymeric polycarboxylates in the cleaning agents according to the invention preferably amounts to 0.5 to 20 wt. % and in particular to 3 to 10 wt. %.

The cleaning agents according to the invention may in particular contain phosphonates as a further builder. The phosphonate compound used preferably takes the form of a hydroxyalkane- and/or aminoalkanephosphonate. Among hydroxyalkanephosphonates, 1-hydroxyethane-1,1-diphosphonate (HEDP) is of particular significance. Aminoalkanephosphonates which may preferably be considered are ethylenediaminetetramethylenephosphonate (EDTMP), diethylenetriaminepentamethylenephosphonate (DTPMP) as well as the higher homologs thereof. Phosphonates are contained in agents according to the invention preferably in quantities of 0.1 to 10 wt. %, in particular in quantities of 0.5 to 8 wt. %, in each case relative to the total weight of the cleaning agent.

Preferably at least one compound selected from MGDA, GLDA and EDDS is used, in particular in reduced-phosphate and phosphate-free agents.

MGDA (methylglycinediacetic acid), GLDA (glutamic acid-N,N-diacetic acid) and EDDS (ethylenediamine-N,N′-disuccinic acid) are used in cleaning agents according to the invention preferably in quantities of 5 to 60 wt. %, in particular in quantities of 10 to 40 wt. %.

Agents according to the invention further contain as builder crystalline layered silicates of the general formula NaMSiₓO₂ₓ₊₁.yH₂O, in which M represents sodium or hydrogen, x is a number from 1.9 to 22, preferably from 1.9 to 4, wherein more preferred values for x are 2, 3 or 4, and y denotes a number from 0 to 33, preferably from 0 to 20. Amorphous sodium silicates may also be used which have an Na₂O:SiO₂ modulus of 1:2 to 1:3.3, preferably of 1:2 to 1:2.8 and in particular of 1:2 to 1:2.6, which are preferably dissolution-retarded and exhibit secondary washing characteristics.

In preferred cleaning agents according to the invention, the content of silicates, relative to the total weight of the cleaning agent, is restricted to quantities of below 10 wt. %, preferably of below 5 wt. % and in particular of below 2 wt. %. Cleaning agents according to the invention are more preferably silicate-free.

As a complement to the above-stated builders, the agents according to the invention may contain alkali metal hydroxides. These alkalinity donors are preferably used in the cleaning agents in only small quantities, preferably in quantities of below 10 wt. %, preferably of below 6 wt. %, by preference of below 5 wt. %, more preferably between 0.1 and 5 wt. % and in particular between 0.5 and 5 wt. %, in each case relative to the total weight of the cleaning agent. Alternative cleaning agents according to the invention are free of alkali metal hydroxides.

Cleaning agents according to the invention preferably contain enzyme(s) as a further component. These include in particular proteases, amylases, lipases, hemicellulases, cellulases, perhydrolases or oxidoreductases, and preferably mixtures thereof. These enzymes are in principle of natural origin; starting from the natural molecules, improved variants are available for use in cleaning agents, said variants accordingly preferably being used. Cleaning agents according to the invention preferably contain enzymes in total quantities of 1×10⁻⁶ to 5 wt. % relative to active protein. Protein concentration may be determined with the assistance of known methods, for example the BCA method or the biuret method.

Among proteases, those of the subtilisin type are preferred. Examples of these are subtilisins BPN′ and Carlsberg and their further developed forms protease PB92, subtilisins 147 and 309, alkaline protease from Bacillus lentils, subtilisin DY and the enzymes thermitase, proteinase K and proteases TW3 and TW7, which are classed among subtilases but no longer among the subtilisins as more narrowly defined.

Examples of amylases usable according to the invention are the α-amylases from Bacillus licheniformis, from B. amyloliquefaciens, from B. stearothermophilus, from Aspergillus niger and A. oryzae and the further developed forms of the above-stated amylases which have been improved for use in detergents and cleaning agents. Particular note should furthermore be taken for this purpose of the α-amylase from Bacillus sp. A 7-7 (DSM 12368) and the cyclodextrin glucanotransferase (CGTase) from B. agaradherens (DSM 9948).

Lipases or cutinases, in particular because of their triglyceride-cleaving activities, but also in order to produce peracids in situ from suitable precursors may furthermore be used according to the invention. These include, for example, lipases originally obtainable or further developed from Humicola lanuginosa (Thermomyces lanuginosus), in particular those with the D96L amino acid substitution.

Enzymes which fall within the class of hemicellulases may furthermore be used. These include, for example, mannanases, xanthan lyases, pectin lyases (=pectinases), pectin esterases, pectate lyases, xyloglucanases (=xylanases), pullulanases and β-glucanases.

Oxidoreductases, for example oxidases, oxygenases, catalases, peroxidases, such as halo-, chloro-, bromo-, lignin, glucose or manganese peroxidases, dioxygenases or laccases (phenol oxidases, polyphenol oxidases) may be used according to the invention to increase bleaching action. Compounds, preferably organic compounds, more preferably aromatic compounds, which interact with the enzymes are advantageously also added in order to enhance the activity of the oxidoreductases in question (enhancers) or, in the event of a major difference in redox potential between the oxidizing enzymes and the soiling, to ensure electron flow (mediators).

A protein and/or enzyme may be protected, particularly during storage, from damage such as for example inactivation, denaturation or degradation for instance due to physical influences, oxidation or proteolytic cleavage. If the proteins and/or enzymes are isolated from microbes, inhibition of proteolysis is more preferred, in particular if the preparations also contain proteases. Cleaning agents may contain stabilizers for this purpose; the provision of such agents constitutes a preferred embodiment of the present invention.

Proteases and amylases with a cleaning action are not generally provided in the form of the pure protein but rather in the form of stabilized storable and transportable preparations. These preformulated preparations include, for example, solid preparations obtained by granulation, extrusion or freeze-drying or, in particular in the case of agents in liquid or gel form, solutions of the enzymes, advantageously as concentrated as possible, with a low water content and/or combined with stabilizers or further auxiliaries.

Alternatively, both for the solid and the liquid presentation, the enzymes may be encapsulated, for example by spray drying or extruding the enzyme solution together with a preferably natural polymer or in the form of capsules, for example those in which the enzymes are enclosed for instance in a solidified gel or those of the core-shell type, in which an enzyme-containing core is coated with a protective layer which is impermeable to water, air and/or chemicals. Further active substances, for example stabilizers, emulsifiers, pigments, bleaching agents or dyes may additionally be applied in superimposed layers. Such capsules are applied in accordance with per se known methods, for example by agitated or rolling granulation or in fluidized bed processes. Advantageously, such granules are low-dusting, for example due to the application of polymeric film formers, and stable in storage thanks to the coating.

It is furthermore possible to formulate two or more enzymes together such that a single granular product comprises two or more enzyme activities.

As is clear from the preceding explanations, the enzyme protein constitutes only a fraction of the total weight of conventional enzyme preparations. Protease and amylase preparations preferably used according to the invention contain between 0.1 and 40 wt. %, preferably between 0.2 and 30 wt. %, more preferably between 0.4 and 20 wt. % and in particular between 0.8 and 10 wt. % of the enzyme protein.

Preferred cleaning agents are in particular those which, in each case relative to the total weight thereof, contain 0.1 to 12 wt. %, preferably 0.2 to 10 wt. % and in particular 0.5 to 8 wt. % of enzyme preparations.

Agents according to the invention preferably contain at least one further component, preferably selected from the group consisting of anionic, cationic and amphoteric surfactants, bleaching agents, bleach activators, bleach catalysts, further solvents, thickeners, sequestering agents, electrolytes, corrosion inhibitors, in particular silver protection agents, glass corrosion inhibitors, foam inhibitors, dyes, scents and antimicrobial active substances.

Agents according to the invention preferably contain as further solvent at least one alkanolamine. The alkanolamine is here preferably selected from the group consisting of mono-, di-, triethanol- and -propanolamine and mixtures thereof. The alkanolamine is present in agents according to the invention preferably in a quantity of 0.5 to 10 wt. %, in particular in a quantity of 1 to 6 wt. %.

Zinc salts are preferably used as glass corrosion inhibitors. Glass corrosion inhibitors are present in agents according to the invention preferably in a quantity of 0.05 to 5 wt. %, in particular in a quantity of 0.1 to 2 wt. %.

### Examples

Three liquid cleaning agents with water contents of below 20 wt. % were produced (Invention 1 and Comparison 1 and Comparison 2), wherein water or the aqueous phosphate solution was initially introduced and the sulfopolymer was in each case introduced into the liquid mixture in solid form.

TABLE 1
Quantities stated in wt. %

| Composition | Invention 1 | Comparison 1 | Comparison 2 |
|---|---|---|---|
| Potassium/sodium | 21 | 21 | 21 |
| tripolyphosphate | | | |
| Sodium citrate | 5 | 5 | 5 |
| dihydrate | | | |
| Phosphonate | 2 | 2 | 2 |
| Cationic surfactant | 1 | 1 | 1 |
| Nonionic surfactant | 4 | 4 | 4 |
| Ethanolamine | 3 | 3 | 3 |
| Glycerol | 5 | . . . | . . . |
| Propylene glycol | 25 | . . . | . . . |
| Paraffin oil | . . . | 30 | . . . |
| Polyethylene glycol | | | 30 |
| (PEG 1500) | | | |
| Enzyme preparations | 4 | 4 | 4 |
| (protease, | | | |
| amylase) | | | |
| Cumenesulfonate | 1 | 1 | 1 |
| Sulfopolymer (solid) | 10 | 10 | 10 |
| Perfume, dyes, | <0.5 | <0.5 | <0.5 |
| corrosion inhibitors | | | |
| Water | Ad 100 | Ad 100 | Ad 100 |

Only the agent Invention 1 according to the invention could be produced stably and without difficulties, while with Comparison 1 and Comparison 2 it was not possible even to incorporate the solid sulfopolymer.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A liquid cleaning agent in a water-soluble packaging containing at least one sulfopolymer and at least one polyhydric alcohol.

2. The cleaning agent according to claim 1, characterized in that it contains 20 to 50 wt. % of polyhydric alcohol selected from the group consisting of glycerol, ethylene glycol, 1,2-propylene glycol, 1,3-propylene glycol and mixtures thereof.

3. The cleaning agent according to claim 1, comprising 1,2-propylene glycol as the polyhydric alcohol in a quantity of 15 to 35 wt. %.

4. The cleaning agent according to claim 2, wherein it contains a mixture of glycerol and 1,2-propylene glycol, wherein the glycerol is used in a quantity of 1 to 10 wt. %, and the 1,2-propylene glycol in a quantity of 15 to 35 wt. %, in each case relative to the total quantity of the cleaning agent, wherein the total quantity of glycerol and 1,2-propylene glycol amounts to 25 to 45 wt. %.

5. The cleaning agent according to claim 1, characterized in that the composition contains at most 25 wt. % of water.

6. The cleaning agent according to claim 1, wherein it contains sulfopolymer which was used in the production of the agent in solid form.

7. The cleaning agent according to claim 1, wherein the water-soluble packaging is a polyvinyl alcohol-containing film.

8. The cleaning agent according to claim 1, wherein the sulfopolymer used is a polymer comprising
i) monomers containing carboxylic acid groups,
ii) monomers containing sulfonic acid groups,
iii) optionally nonionic, in particular hydrophobic, monomers
wherein the total quantity of sulfopolymer amounts to 1 to 15 wt. %, and wherein the agent further comprises 0.5 to 10 wt. % of at least one hydroxy mixed ether.

10. The cleaning agent according to claim 1, characterized in that it has a viscosity of above 4000 mPa·s (Brookfield Viscometer DV-II+Pro, spindle 25, 30 rpm, 20° C.).

11. A method for producing a liquid cleaning agent in a water-soluble packaging according to claim 1, characterized in that the sulfopolymer is used in solid form.

12. An automatic dishwashing method, characterized in that a cleaning agent according to claim 1 is used.
